(19) United States
(12) Patent Application Publication
(10) Pub. No.: US 2013/0179263 A1
(43) Pub. Date: Jul. 11, 2013

(54) CONTEXTUALLY LINKING PEOPLE TO STRATEGIC LOCATIONS

(71) Applicant: Eric Leebow, New York, NY (US)

(72) Inventor: Eric Leebow, New York, NY (US)

(21) Appl. No.: 13/348,282

(22) Filed: Jan. 11, 2012

(51) Int. Cl. G06Q 30/02; G06F 15/16

(52) U.S. Cl. 705/14.58; 709/205

(57) ABSTRACT

In a method for linking a person to a location, a computer determines that a device of a person is within a predetermined distance of a location, based on data received from the device. The computer identifies the at least one of the person and the device, determined to be within a predetermined distance of the location, based on the received data. The computer associates the at least one of the person and the device with the location. The computer generates a message based on the association. The computer communicates the message to the person.

### FIELD OF THE INVENTION

The present disclosure relates to detecting people at a location. More particularly, the present disclosure relates to contextually linking people to strategic locations.

### BACKGROUND

In the course of a daily routine, a person passes by various other people and places. The same person may pass another person or place several times in a day or over a given time period. For example, a person may frequently go up or down escalators or elevators in a favorite store or building. Similarly, a person may walk or drive by a storefront or a billboard advertisement on a daily basis on their way to work. Another person may also frequently go up or down the same escalator in the same store or building or pass by the same storefront on their way to work.

An owner of a store may desire to target an advertisement to people who frequently pass by the store on their way to work. The owner of the store may not know, however, which people pass by the store on a daily basis on their way to work. Further, a person may be interested in knowing that another person also frequently goes up the same escalator or passes by the same store on a daily basis on their way to work, since it may indicate that the person has similar interests or works in the same vicinity as the other person. Thus, the two people may wish to meet. The two people may not be aware, however, that they both pass by the same location frequently if they pass the location at different times or if they simply have not noticed one another when passing by the same location.

### SUMMARY

In a method for linking a person to a location, a computer determines that a device of a person is within a predetermined distance of a location, based on data received from the device. The computer identifies the at least one of the person and the device, determined to be within a predetermined distance of the location, based on the received data. The computer associates the at least one of the person and the device with the location. The computer generates a message based on the association. The computer communicates the message to the person.

A system for linking a person to a location has a receiver for receiving data from a device of a person. The system has at least one processor, at least one computer-readable tangible storage device, and program instructions stored on the at least one storage device for execution by the at least one processor. The program instructions, when executed, determine that the device of the person is within a predetermined distance of a location, based on the received data. The program instructions, when executed, identify the at least one of the person and the device, determined to be within a predetermined distance of the location, based on the received data. The program instructions, when executed, associate the at least one of the person and the device with the location. The program instructions, when executed, generate a message based on the association. The system has a transmitter to communicate the message to the person.

A computer program product for linking a person to a location has at least one computer-readable tangible storage device and program instructions stored on the at least one storage device. The program instructions, when executed, determine that a device of a person is within a predetermined distance of a location, based on data received from the device. The program instructions, when executed, identify the at least one of the person and the device determined to be within a predetermined distance of the location, based on the received data. The program instructions, when executed, associate the at least one of the person and the device with the location. The program instructions, when executed, generate a message based on the association. The program instructions, when executed, communicate the message to the person.

### BRIEF DESCRIPTION OF THE DRAWINGS

The accompanying drawings, which are incorporated in and constitute a part of the specification, illustrate various example systems, methods, and so on, of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example system for contextually linking people to a strategic location.

FIG. 2 illustrates the example system of FIG. 1 for contextually linking people to an escalator.

FIG. 3 illustrates the example system of FIG. 1 for contextually linking people to a storefront.

FIG. 4 is a block diagram of the example system of FIG. 1 for contextually linking people to a strategic location.

FIG. 5 is a flow chart illustrating an example method for contextually linking people to a strategic location.

FIG. 6 is a block diagram of an example computing device for implementing an example system for contextually linking people to a strategic location.

### DETAILED DESCRIPTION

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

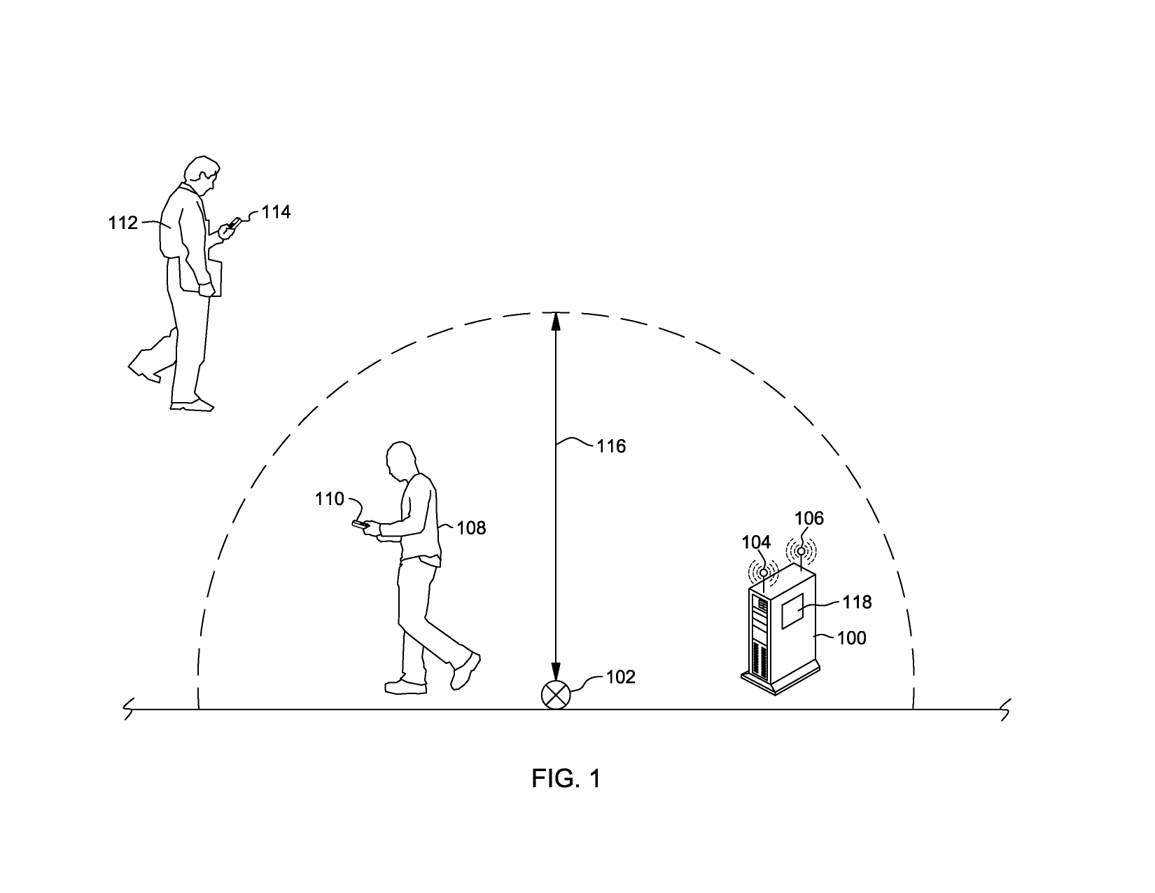

FIG. 1 illustrates a computer system 100 for contextually linking people to a strategic location. Contextually linking people to strategic locations involves linking a person to a physical location and establishing a context for the person based on the physical location. Computer system 100 is placed within or near location 102. Computer system 100 has a linking program 118 for receiving data from a device 110 of a person 108 determined to be within a predefined distance 116 of location 102, for identifying person 108 or device 110, for contextually linking or associating person 108 or device 110 with location 102, and for generating messages based on the contextual link. Computer system 100 ignores a person 112 outside a predefined distance 116 of location 102.

Computer system 100 has a receiver 104 for receiving information from a device 110 of a person 108. Although device 110 is depicted in the example embodiment as a mobile telephone, it should be understood that device 110 may be a personal digital assistant (PDA), a tablet computer, a music player, a mobile game console, a device attached to a key chain, a portable personal computer or any other type of electronic device capable of transmitting information to receiver 104. In an alternative example embodiment, device 110 is a Radio Frequency Identification (RFID) tag connected to an item of person 108.

Receiver 104 is configured to only receive data being transmitted from a device when the device is within a predefined distance 116 from location 102. Thus, if a person 112 is outside of the predefined distance 116, even if a device 114 of the person 112 transmits data similarly to device 110 of person 108, receiver 104 does not detect data being transmitted by device 114 of person 112. In an example embodiment, the predefined distance 116 is configurable according to a user preference.

Linking program 118 is capable of making an association or link between person 108 and location 102, based on information received about person 108, information about location 102, and information about the number of instances that person 108 has been detected at location 102 over a given period of time. The resulting association can be used for targeted advertising or for social networking, for example.

Computer system 100 has a transmitter 106 for communicating a message generated by linking program 118 to person 108. In an example embodiment, transmitter 106 communicates the message to person 108 via device 110 of person. For example, transmitter 106 may communicate a message to device 110 via Short Message Service (SMS). Alternatively, transmitter 106 may communicate a message to device 110 via Multimedia Messaging Service (MMS), electronic mail, or any other computer communication. In an example embodiment, transmitter 106 may communicate the message to person 108 visually via a display screen (not shown), audibly via a speaker (not shown), or via some other known method of communicating messages to a person.

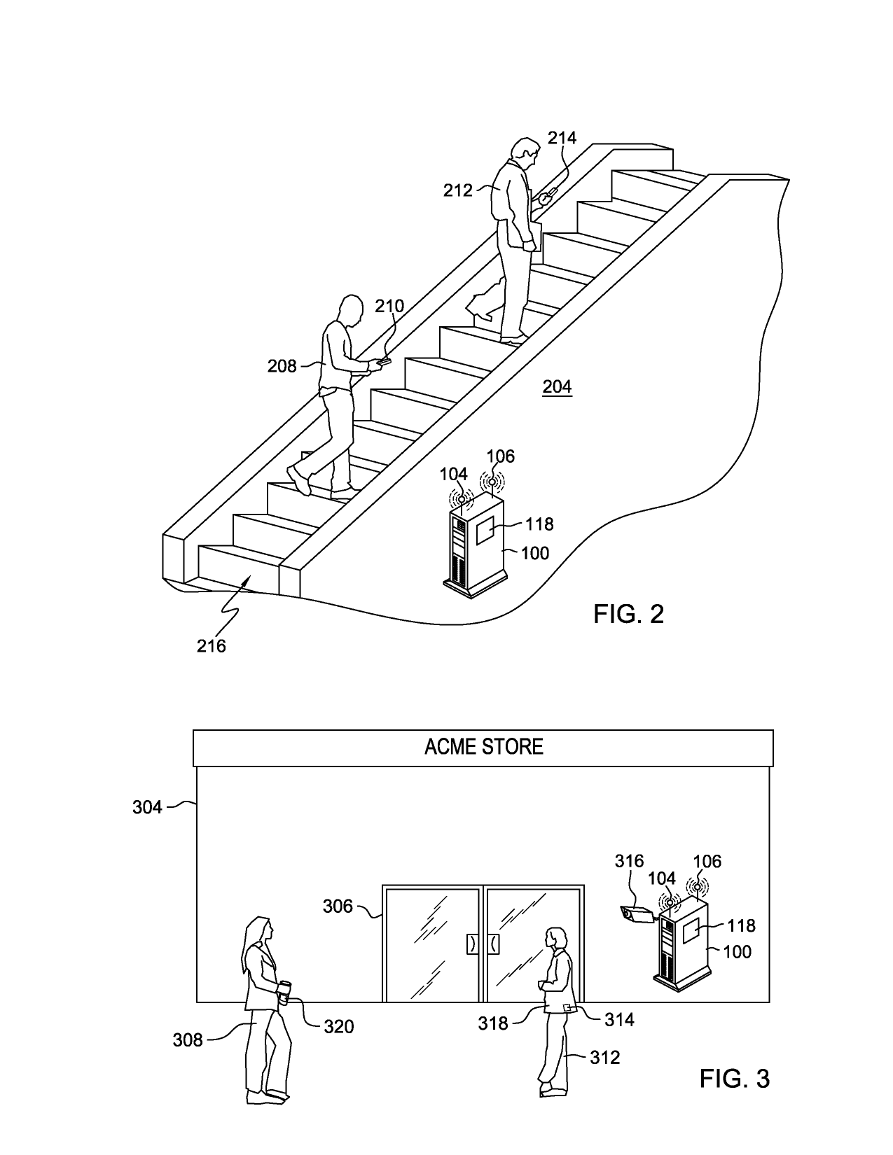

It should be understood by those skilled in the art that computer system 100 depicted in FIG. 1 may be implemented in a variety of locations. FIG. 2 illustrates the example computer system 100 of FIG. 1 for contextually linking people to an escalator 204. Computer system 100 is placed near escalator 204. In an example embodiment, computer system 100 is placed near the entrance 216 of escalator 204. Computer system 100 has a linking program 118 for detecting person 208, as person 208 enters escalator 204 at entrance 216, for contextually linking or associating person 208 with escalator 204, and for generating a message based on the contextual link. Computer system 100 has a receiver 104 for receiving data from a device 210 of person 208. Computer system 100 has a transmitter 106 for communicating a message generated by linking program 118 to person 208.

In an example embodiment, linking program 118 correlates data received from device 210 of person 208 with data received from device 214 of other person 212. Linking program 118 may generate a message based on the correlation. For example, if both person 208 and other person 212 frequently use escalator 204, linking program 118 may generate a message for person 208, suggesting other person 212 as a possible social connection. Further, if both person 208 and other person 212 have similar roles or are members of a similar class, linking program 118 may generate a message based on that role. For example, if both person 208 and other person 212 are doctors, a message may indicate that the escalator is frequented by doctors. A message may also suggest, to a potential advertiser, that the escalator may be a good location for target advertisements directed to doctors.

FIG. 3 illustrates the example computer system 100 of FIG. 1 for contextually linking people to a storefront 304. Computer system 100 is placed near storefront 304. In an example embodiment, computer system 100 is placed near the entrance 306 of storefront 304. Computer system 100 has a linking program 118 for detecting person 308, as person 308 enters storefront 304 or passes by storefront 304 at entrance 306, for contextually linking or associating person 308 with storefront 304, and for generating a message based on the contextual link. Computer system 100 has a receiver 104 for receiving data from a device 320 of person 308. Computer system 100 has a transmitter 106 for communicating a message generated by linking program 118 to person 308.

For example, person 308 may walk or drive by the storefront 304 on a regular basis, but may have never shopped in the store, as determined by linking program 118. Such information can be used for targeted advertising. For example, transmitter 106 may communicate an electronic mail message, SMS message, MMS message, or other message to device 320 of person 308 saying “Did you know that you walk by our store on a daily basis? Why don't you stop and take a look?”

In an example embodiment, linking program 118 correlates data received from device 320 of person 308 with data received from device 314 of other person 312. Linking program 118 may generate a message based on the correlation. For example, if both person 308 and other person 312 frequently pass by or enter storefront 304, linking program 118 may generate a message for person 308, suggesting other person 312 as a possible social connection.

In an example embodiment, device 314 of person 312 is an RFID tag incorporated in a shirt 318. Thus, linking program 118 links shirt 318 with storefront 304 and generates a communication based on the link. For example, the communication may say “I see you have an ACME shirt. Did you know ACME shirts are on sale today for 20% off!” Similarly, in an example embodiment, device 320 of person 308 is an RFID tag incorporated in a coffee cup 320. Thus linking program 118 links coffee cup 320 with storefront 304 and generates a communication based on the link. It should be understood by one skilled in the art that, although FIG. 3 depicts devices 314 and 320 as RFID tags incorporated in shirt 318 and coffee cup 320, devices 314 and 320 can be any electronic device capable of transmitting data. Additionally, devices 314 and 320 may be incorporated in a variety of different types of items. For example, devices 314 and 320 may be incorporated into a book, shoes, or other such items which a retailer may chose to detect and associate with a storefront 304.

In one example, a device may be an RFID tag incorporated into a car (not shown). Thus, as a person drives by a storefront or a billboard advertisement in his car, linking program 118 may link the car with the storefront or the billboard advertisement and generate a communication based on the link. In one example, both a car and a device of a person may incorporate an RFID tag or other similar device capable of transmitting data. In such an example, linking program 118 may link an individual driving the car and the storefront or billboard and generate a communication based on the 3-way link. Additionally, a car may include two RFID tags, or other similar communication devices such as near field communication chips, to identify both a driver and passenger to linking program 118. Thus, linking program 118 communicate a first message to a driver of a car and communicate a second message to a passenger of the car. It should be understood that although the example embodiments refer to linking program 118 linking drivers and passengers to a moving car, linking program 118 may also be implemented to similarly link people to bicycles, boats, or other similar moving vehicles.

In an example embodiment, computer system 100 has a camera 316 for taking a picture of person 308 as person 308 passes or enters storefront 304. Linking program 118 may use facial recognition technology to identify person 308 in the picture and to link person 308 to storefront 304 or to other person 312.

It should be understood by one skilled in the art that, in addition to the escalator and storefront examples illustrated in FIGS. 2 and 3, computer system 100 may be placed in other locations including, but not limited to, an elevator, a treadmill, a bus stop, and so on.

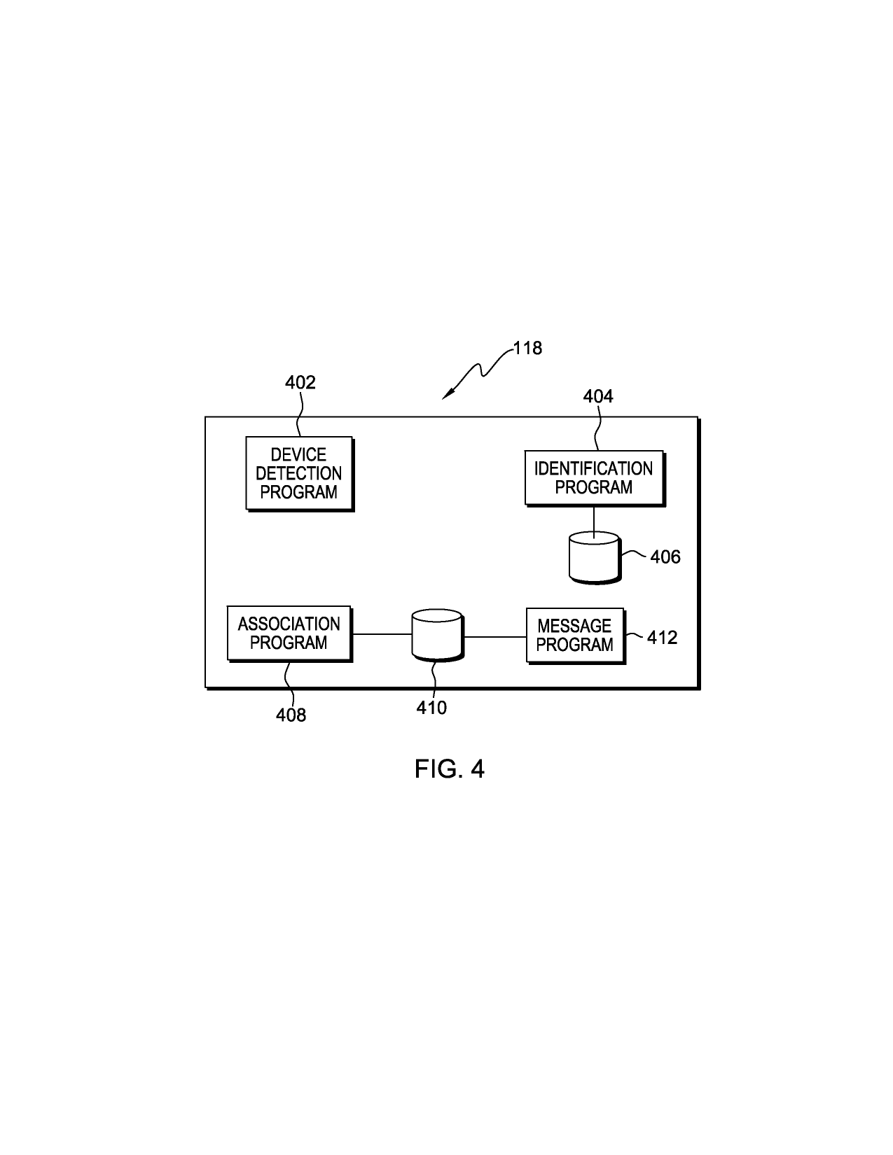

FIG. 4 illustrates a block diagram of linking program 118 of FIG. 1 for contextually linking people to a strategic location. Linking program 118 has a device detection program 402 for detecting a device at a strategic location. The device is carried by a person (not shown) who is located or passes near the strategic location. The device transmits a beacon signal including data which identifies the device, the person who owns the device, or both. The device can be, but is not limited to, a mobile telephone, a laptop computer, a tablet computer, a music player, a mobile game console, a PDA, a device attached to a key chain, and so on. Device detection program 402 receives data from a device, via receiver 104, and is able to determine, based on the received data, whether the device is within a predetermined distance of the strategic location.

To address issues of battery drainage and accuracy of location, a short range transmission system such as Bluetooth may be used for transmission and detection of the beacon signal 330. In other embodiments, the transmission and detection may be implemented by means of RFID or other technology that incorporates the traits of short range transmission and relatively low power consumption.

Linking program 118 has an identification program 404 for identifying a device, or a person carrying the device, based on data received by device detection program 402. Linking program 118 also has an identification database 406 for storing information about people or devices. For example, device detection program 402 may receive, from a mobile phone, data including the telephone number associated with the mobile phone. Identification program 404 may access a phonebook in identification database 406 to retrieve information about a person carrying the mobile phone. Alternatively, device detection program 402 may receive a picture of a person from a camera. Identification program 404 may access a photo directory in identification database 406 to identify the person in the picture. In one example, identification program 404 may access an external database, via a wireless network connection, to identify a person or device near the strategic location.

Linking program 118 has an association program 408 for relating the data identifying the device or the person carrying the device to data identifying the strategic location. Association program 408 may further relate the data identifying the device or the person carrying the device to data related to the strategic location based on the relation between the data identifying the device and the data identifying the strategic location. Linking program 118 has an association database 410 for storing associations created by association program 408. For example, association program 408 may store an association in association database 410 indicating that a particular person passed by a particular location at a given time.

Linking program 118 has a message program 412 to generate a message based on the association created by association program 408. For example, message program 412 may generate a message to offer a person a discount at a store in response to association program 408 associating the person with the store. In an example embodiment, message program 412 analyzes data previously stored in association database 410 to generate the message. For example, message program 412 may determine that a person frequently passes by a coffee shop. Message program 412 may also determine that other person also frequently passes by the same coffee shop at approximately the same time. In response, message program 412 may generate a message to suggest to the person, the other person as a possible social connection.

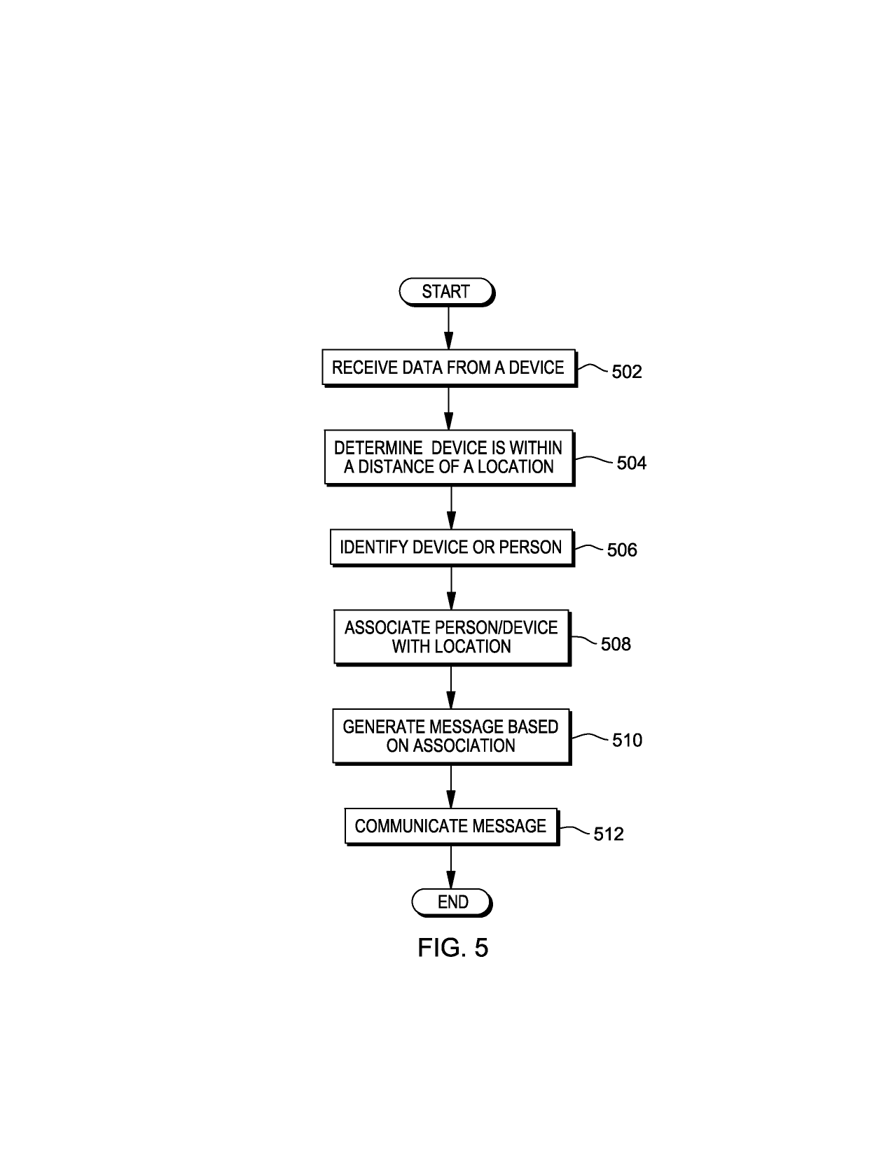

Example methods may be better appreciated with reference to the flow diagrams of FIG. 5. While for purposes of simplicity of explanation, the illustrated methodologies are shown and described as a series of blocks, it is to be appreciated that the methodologies are not limited by the order of the blocks shown or described, as some blocks can occur in different orders or concurrently with other blocks. Moreover, less than all the illustrated blocks may be required to implement an example methodology. Furthermore, additional or alternative methodologies can employ additional blocks, not illustrated.

In the flow diagrams, blocks denote “processing blocks” that may be implemented with logic. The processing blocks may represent a method step or an apparatus element for performing the method step. A flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on, are not shown. It will be further appreciated that electronic and software applications may involve dynamic and flexible processes so that the illustrated blocks can be performed in other sequences that are different from those shown or that blocks may be combined or separated into multiple components. It will be appreciated that the processes may be implemented using various programming approaches like machine language, procedural, object oriented or artificial intelligence techniques.

In one example, methodologies are implemented as processor executable instructions or operations provided on a computer-readable medium. Thus, in one example, a computer-readable medium may store processor executable instructions operable to perform a method. While the above method is described as being provided on a computer-readable medium, it is to be appreciated that other example methods described herein can also be provided on a computer-readable medium.

While FIG. 5 illustrates various actions occurring in serial, it is to be appreciated that various actions illustrated could occur substantially in parallel. While a number of processes are described, it is to be appreciated that a greater or lesser number of processes could be employed and that lightweight processes, regular processes, threads, and other approaches could be employed. It is to be appreciated that other example methods may, in some cases, also include actions that occur substantially in parallel.

FIG. 5 is a flow chart illustrating an example method for contextually linking people to a strategic location. At step 502, device detection program 402 receives data, via receiver 104, from a device. Data can be in the form of a data signal from a mobile telephone, a radio wave from an RFID tag, a digital picture from a camera, or any similar form of data indicative of a device or a person associated with the device.

At step 504, device detection program 403 determines that the device is within a predefined distance of a strategic location. In one example, device detection program is configured to detect a location of a device based on the data received from the device. For example, received data may include GPS information or other similar information indicative of a device's location. In another example, device detection program 403 is configured to only receive data from devices within a predefined distance. For example, receiver 104 may be a short range RFID reader configured to only read tags in a short, predefined range.

At step 506, identification program 404 identifies a device or a person carrying the device, based on the data received, by accessing identification database 406. At step 508, association program 408 associates the identified person or device with the strategic location to establish a relation between the person and the strategic location. In an example embodiment, association program qualifies the relation between the person and the strategic location. Specifically, the relation between the person and the strategic location may be qualified based on a number of instances that the signal carrying the data identifying the at least one of the person and the mobile device is detected. For example, when a person is detected to walk frequently by a storefront, the relation between the person and the store may be qualified to establish that the person frequently walks by the storefront in contrast with another person whom may have walked by the store only on a few occasions.

In an example embodiment, the relation between the person and the strategic location is qualified to qualify the person based on data related to the strategic location. For example, in detecting a person at an escalator in a department store, an inference may be drawn based on the location itself and on the number of instances that the person has been detected at the location that the person enjoys visiting the department store.

At step 510, message program 412 generates a message, based on the association. At step 512, message program 412 communicates the message to the person, via transmitter 106. Message program 412 may communicate the message via SMS, MMS, electronic mail, or other computer communication to a mobile telephone of the person. Message program 412 may also communicate the message visually or audibly, via transmitter, to an external display or speaker.

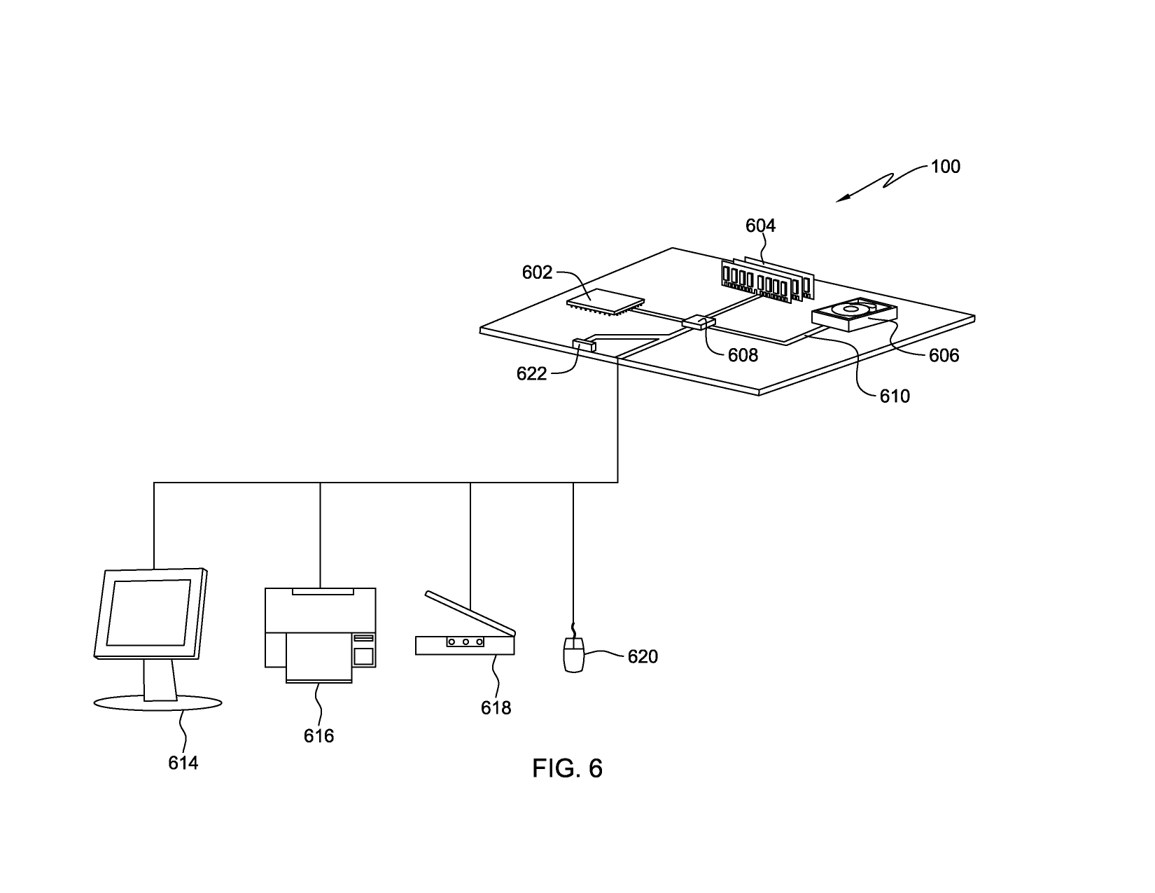

FIG. 6 is a block diagram of an example computer system 100 for contextually linking people to a strategic location. Computer system 100 is intended to represent various forms of digital computers, including laptops, desktops, handheld computers, tablet computers, servers, and other similar types of computing devices. Computer system 100 includes a processor 602, memory 604, a storage device 606, and a communication port 622, operably connected by an interface 608 via a bus 610.

Storage device 606 stores device detection program 402, identification program 404, association program 408, and message program 412, as well as identification database 406 and association database 410.

Processor 602 processes instructions, via memory 604, for execution within computer system 100, including detection program 402, identification program 404, association program 408, and message program 412 stored on storage device 606. In an example embodiment, multiple processors along with multiple memories may be used. In an example embodiment, multiple computer systems 100 may be connected, with each device providing portions of the necessary operations.

Memory 604 may be volatile memory or non-volatile memory. Memory 604 may be a computer-readable medium, such as a magnetic disk or optical disk. Storage device 606 may be a computer-readable medium, such as floppy disk devices, a hard disk device, optical disk device, a tape device, a flash memory, or other similar solid state memory device, or an array of devices, including devices in a storage area network of other configurations. A computer program product can be tangibly embodied in a computer readable medium such as memory 604 or storage device 606. The computer program product may contain detection program 402, identification program 404, association program 408, and message program 412.

Computer system 100 can be coupled to one or more input and output devices such as a display 614, a printer 616, a scanner 618, and a mouse 620.

While example systems, methods, and so on, have been illustrated by describing examples, and while the examples have been described in considerable detail, it is not the intention to restrict or in any way limit the scope of the appended claims to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, and illustrative examples shown or described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

The following includes definitions of selected terms employed herein. The definitions include various examples, forms, or both of components that fall within the scope of a term and that may be used for implementation. The examples are not intended to be limiting. Both singular and plural forms of terms may be within the definitions.

“Computer communication,” as used herein, refers to a communication between two or more computing devices (e.g., computer, personal digital assistant, cellular telephone) and can be, for example, a network transfer, a file transfer, an applet transfer, an email, a hypertext transfer protocol (HTTP) transfer, and so on. A computer communication can occur across, for example, a wireless system (e.g., IEEE 802.11, IEEE 802.15), an Ethernet system (e.g., IEEE 802.3), a token ring system (e.g., IEEE 802.5), a local area network (LAN), a wide area network (WAN), a point-to-point system, a circuit switching system, a packet switching system, combinations thereof, and so on.

“Computer-readable medium,” as used herein, refers to a medium that participates in directly or indirectly providing signals, instructions or data. A computer-readable medium may take forms, including, but not limited to, non-volatile media, volatile media, and transmission media. Non-volatile media may include, for example, optical or magnetic disks, and so on. Volatile media may include, for example, optical or magnetic disks, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic media, a CD-ROM, other optical media, punch cards, paper tape, other physical media with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Data store,” as used herein, refers to a physical or logical entity that can store data. A data store may be, for example, a database, a table, a file, a list, a queue, a heap, a memory, a register, and so on. A data store may reside in one logical or physical entity or may be distributed between two or more logical or physical entities.

“Logic,” as used herein, includes but is not limited to hardware, firmware, software or combinations of each to perform a function(s) or an action(s), or to cause a function or action from another logic, method, or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

“Signal,” as used herein, includes but is not limited to one or more electrical or optical signals, analog or digital signals, data, one or more computer or processor instructions, messages, a bit or bit stream, or other means that can be received, transmitted or detected.

“Software,” as used herein, includes but is not limited to, one or more computer or processor instructions that can be read, interpreted, compiled, or executed and that cause a computer, processor, or other electronic device to perform functions, actions or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servelet, an applet, instructions stored in a memory, part of an operating system or other types of executable instructions. It will be appreciated by one of ordinary skill in the art that the form of software may depend, for example, on requirements of a desired application, the environment in which it runs, or the desires of a designer/programmer or the like. It will also be appreciated that computer-readable or executable instructions can be located in one logic or distributed between two or more communicating, co-operating, or parallel processing logics and thus can be loaded or executed in serial, parallel, massively parallel and other manners.

Suitable software for implementing the various components of the example systems and methods described herein may be produced using programming languages and tools like Java, Java Script, Java.NET, ASP.NET, VB.NET, Cocoa, Pascal, C#, C++, C, CGI, Perl, SQL, APIs, SDKs, assembly, firmware, microcode, or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User,” as used herein, includes but is not limited to one or more persons, software, computers or other devices, or combinations of these.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. A method for linking a person to a location, the method comprising the steps of:
a computer determining that a device of a person is within a predetermined distance of a location, based on data received from the device;
the computer identifying the at least one of the person and the device, based on the received data;
the computer associating the at least one of the person and the device with the location;
the computer generating a message based on the association; and
the computer communicating the message to the person.

2. The method of claim 1, wherein the computer receives the data via a radio frequency identification tag of the device.

3. The method of claim 1, wherein the computer determines that the device of the person is within a predetermined distance of a predetermined escalator.

4. The method of claim 1, wherein the computer associates the at least one of the person and the device with the location by:
time-stamping the received data; and
storing the time-stamped data together with data indicative of the location in a database.

5. The method of claim 4, further comprising the steps of:
the computer grouping the at least one of the person and the device based on a predefined characteristic;
the computer counting a number of instances a person or a device is grouped into a predetermined group, based on the predefined characteristic; and
the computer generating a message, based on the association, comprising the counted number.

6. The method of claim 1, wherein the computer generating a message comprises the computer generating an advertisement targeted to the person.

7. The method of claim 1, wherein the computer generating a message comprises the computer suggesting a social network connection to the person.

8. A system for linking a person to a location, the system comprising:
a receiver configured to receive data from a device of a person;
at least one processor, at least one computer-readable tangible storage device, and program instructions stored on the at least one storage device for execution by the at least one processor, the program instructions comprising:
first program instructions to determine that the device of the person is within a predetermined distance of a location, based on the received data;
second program instructions to identify the at least one of the person and the device, determined to be within a predetermined distance of the location, based on the received data;
third program instructions to associate the at least one of the person and the device with the location; and
fourth program instructions to generate a message based on the association; and
a transmitter to communicate the message to the person.

9. The system of claim 8, further comprising fifth program instructions, stored on the least one storage device for execution by the at least one processor, to receive the data from the device via a radio frequency identification tag of the device.

10. The system of claim 8, wherein the first program instructions to determine that a device of a person is within a predetermined distance of a location, determines that the device of the person is within a predetermined distance of a predetermined escalator.

11. The system of claim 8, wherein the third program instructions to associate the at least one of the person and the device with the location, time-stamps the received data and stores the time-stamped data together with data indicative of the location in a database.

12. The system of claim 11, further comprising:
sixth program instructions, stored on the at least one storage device for execution by the at least one processor, to group the at least one of the person and the device based on a predefined characteristic; and
seventh program instructions, stored on the at least one storage device for execution by the at least one processor, to count a number of times a person or a device is grouped into a predetermined group, based on the predefined characteristic,
wherein the fourth program instructions to generate the message, generates a message comprising the counted number.

13. The system of claim 8, wherein the fourth program instructions to generate the message, generate an advertisement targeted to the person.

14. The system of claim 8, wherein the forth program instructions to generate the message, generates a message suggesting a social network connection to the person.

15. A computer program product for linking a person to a location, the computer program product comprising:
at least one computer-readable tangible storage device and program instructions stored on the at least one storage device, the program instructions comprising:
first program instructions to determine that a device of a person is within a predetermined distance of a location, based on data received from the device;
second program instructions to identify the at least one of the person and the device, determined to be within a predetermined distance of the location, based on the received data;
third program instructions to associate the at least one of the person and the device with the location;
fourth program instructions to generate a message based on the association; and
fifth program instructions to communicate the message to the person.

16. The computer program product of claim 15, further comprising sixth program instructions, stored on the at least one storage device, to receive the data from the device via a radio frequency identification tag of the device.

17. The computer program product of claim 15, wherein the third program instructions to associates the at least one of the person and the device with the location, time-stamps the received data and stores the time-stamped data together with data indicative of the location in a database.

18. The computer program product of claim 15, further comprising:
seventh program instructions, stored on the at least one storage device, to group the at least one of the person and the device based on a predefined characteristic; and
eighth program instructions, stored on the at least one storage device, to count a number of times a person or a device is grouped into a predetermined group, based on the predefined characteristic;
wherein the fourth program instructions to generate the message, generates a message comprising the counted number.

19. The computer program product of claim 15, wherein the fourth program instructions to generate the message, generate an advertisement targeted to the person.

20. The computer program product of claim 15, wherein the fourth program instructions to generate the message, generates a message suggesting a social network connection to the person.
